(19) United States
(12) Patent Application Publication
(10) Pub. No.: US 2025/0294270 A1
(43) Pub. Date: Sep. 18, 2025

(54) DEVICE, CONTROL APPARATUS, AND SYSTEM

(71) Applicant: CANON KABUSHIKI KAISHA, Tokyo (JP)

(72) Inventor: TSUKASA MATSUI, Kanagawa (JP)

(21) Appl. No.: 19/072,875

(22) Filed: Mar. 6, 2025

(30) Foreign Application Priority Data
Mar. 15, 2024 (JP) 2024-041584

(51) Int. Cl. H04N 25/773; H04N 23/56; H04N 25/78

(52) U.S. Cl. CPC H04N 25/773; H04N 23/56; H04N 25/78

(57) ABSTRACT

A device includes a sensor having first and second pixels for outputting digital data corresponding to the number of incident photons, and controller for controlling projector. The first and second pixels are sensitive to first and second wavelength ranges, respectively. The projector generates projection light including the second wavelength range. The controller controls the projector to define effective emission period, and non-effective emission period. First period in which the first pixel performs image sensing includes at least part of the non-effective emission period. Second period in which the second pixel performs image sensing includes at least part of the effective emission period and at least part of the non-effective emission period.

### BACKGROUND

### Technical Field

The aspect of the embodiments relates to a device, a control apparatus, and a system.

### Description of the Related Art

In mixed reality in which information of a virtual space is superposed on a physical space in real time and presented to a user, the three-dimensional shape of an object or the like present in the physical space is to be estimated. A higher mixed reality can be obtained especially by quickly estimating at high precision the three-dimensional shape of a specific object in a physical space superimposed on a virtual space. To achieve this, there is a method of simultaneously performing image sensing of a physical space and estimation of a three-dimensional shape. Japanese Patent Laid-Open No. 2008-8700 discloses a distance image sensor that performs irradiation of an image sensing target space with IR pulses in every two 1-frame scanning periods while performing image sensing with visible light and infrared light in every 1-frame scanning period by a solid-state image sensing device capable of image sensing with visible light and infrared light. The distance image sensor generates a distance image from which the influence of an infrared component in external light is removed by subtracting an IR pixel signal obtained by image sensing at the time of no irradiation with an IR pulse from an IR pixel signal obtained by image sensing at the time of irradiation with an IR pulse.

In a device that senses images of different wavelength ranges such as the visible light range and the infrared range, if image sensing periods by pixels of two types are exclusively set to perform image sensing in the different wavelength ranges, it sometimes becomes difficult to obtain images having qualities suited to the respective purposes of the pixels of two types.

### SUMMARY

A device comprising: a sensor including a plurality of pixels configured to output digital data corresponding to the number of incident photons; and a controller configured to control a projector, wherein the plurality of pixels include a first pixel sensitive to light of a first wavelength range, and a second pixel sensitive to light of a second wavelength range, the projector generates projection light including the second wavelength range, the controller controls the projector to define an effective emission period in which an intensity of the projection light is higher than a predetermined intensity, and a non-effective emission period in which the intensity of the projection light is lower than the predetermined intensity, a first period in which the first pixel performs image sensing includes at least part of the non-effective emission period, and a second period in which the second pixel performs image sensing includes at least part of the effective emission period and at least part of the non-effective emission period.

Further features of the disclosure will become apparent from the following description of exemplary embodiments with reference to the attached drawings.

### BRIEF DESCRIPTION OF THE DRAWINGS

FIG. 1 is a block diagram showing the arrangement of an image sensing system according to the first embodiment;

FIG. 2 is a view exemplifying the array of a plurality of pixels in an image sensor according to the first embodiment;

FIG. 3 is a diagram showing the arrangement of the image sensor, and a detailed arrangement example of the pixels of the image sensor according to the first embodiment;

FIG. 4 is a timing chart exemplifying the operation of the image sensing system according to the first embodiment;

FIGS. 5A and 5B are views schematically showing the first image and the second image sensed by the image sensing system according to the first embodiment;

FIG. 6 is a block diagram exemplifying the operation of an image sensing system according to the second embodiment;

FIG. 7 is a flowchart exemplifying the operation of the image sensing system according to the second embodiment;

FIG. 8 is a flowchart exemplifying the operation of an image sensing system according to the third embodiment;

FIG. 9 is a flowchart exemplifying the operation of an image sensing system according to the fourth embodiment;

FIG. 10 is a block diagram showing the arrangement of an image sensing system according to the fifth embodiment;

FIG. 11 is a diagram showing the arrangement of an image sensor, and a detailed arrangement example of the pixels of the image sensor according to the fifth embodiment;

FIG. 12 is a timing chart exemplifying the operation of the image sensing system according to the fifth embodiment;

FIG. 13 is a block diagram showing the arrangement of an image sensing system according to the sixth embodiment;

FIG. 14 is a diagram showing the arrangement of an image sensor, and a detailed arrangement example of the pixels of the image sensor according to the sixth embodiment;

FIG. 15 is a timing chart exemplifying the operation of the image sensing system according to the sixth embodiment;

FIG. 16 is a block diagram showing the arrangement of an image sensing system according to the seventh embodiment;

FIG. 17 is a diagram showing the arrangement of an image sensor, and a detailed arrangement example of the pixels of the image sensor according to the seventh embodiment;

FIG. 18 is a timing chart exemplifying the operation of the image sensing system according to the seventh embodiment;

FIG. 19 is a block diagram exemplifying the operation of an image sensing system according to the eighth embodiment; and

FIG. 20 is a diagram showing the arrangement of an image sensor, and a detailed arrangement example of the pixels of the image sensor according to the eighth embodiment.

### DESCRIPTION OF THE EMBODIMENTS

Hereinafter, embodiments will be described in detail with reference to the attached drawings. Note, the following embodiments are not intended to limit the scope of the disclosure. Multiple features are described in the embodiments, but limitation is not made to an disclosure that requires all such features, and multiple such features may be combined as appropriate. Furthermore, in the attached drawings, the same reference numerals are given to the same or similar configurations, and redundant description thereof is omitted.

An image sensing system to be described below is an application example of a photoelectric conversion device or a photoelectric conversion system according to one aspect of the embodiments.

### First Embodiment

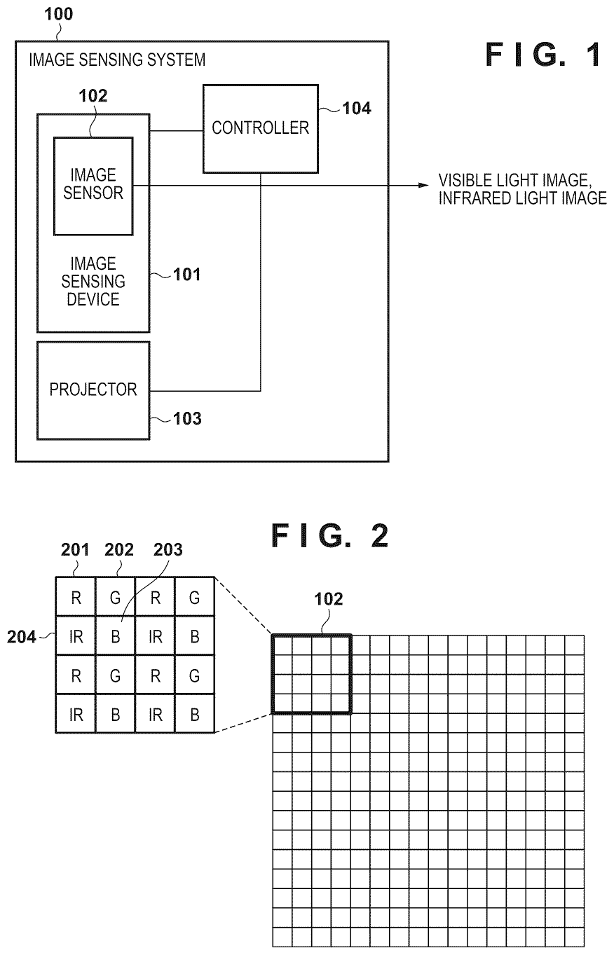

An image sensing system 100 according to the first embodiment will be explained with reference to FIGS. 1, 2, 3, 4, 5, and 6. FIG. 1 shows the arrangement of an image sensing system 100 according to the first embodiment. The image sensing system 100 can include an image sensing device 101, a projector 103, and a controller 104. The image sensing device 101 includes an image sensor 102. The image sensor 102 can include a plurality of pixels that output digital data (pixel values) corresponding to the number of incident photons. In an example, these pixels can include an Avalanche Photo Diode (APD). The plurality of pixels can include the first pixel sensitive to light of the first wavelength range, and the second pixel sensitive to light of the second wavelength range different from the first wavelength range. An example in which the first wavelength range is the wavelength range of visible light and the second wavelength range is the wavelength range of infrared light (infrared ray) will be explained here, but this is merely an example. For example, both the first and second wavelength ranges may be different wavelength ranges in the wavelength range of visible light.

The image sensing device 101 can include an optical system that forms an optical image of an image sensing target on the image sensing surface of the image sensor 102. The projector 103 projects projection light of the second wavelength range (wavelength range of infrared light in this example) to a region covering the angle of view of the image sensing device 101. The projection light can be, for example, patterned light (pattern light). In one embodiment, a pattern in the pattern light is a random pattern in which similar portions do not appear in a projected region. However, the pattern is not limited to this and may be, for example, a dot pattern or a grid pattern. The projection light may be uniform light. The controller 104 can be configured to control the projector 103. The controller 104 may be configured to control the image sensing device 101. Alternatively, the controller 104 may be assembled in the image sensing device 101. The image sensing system 100 can be configured to sense the first image (image of visible light here) using a plurality of first pixels, and sense the second image (image of infrared light and visible light here) using a plurality of second pixels.

FIG. 2 exemplifies the array of a plurality of pixels in the image sensor 102. The pixels of the image sensor 102 include, for example, pixels of three types, for example, R pixels 201, G pixels 202, and B pixels 203 as pixels sensitive to visible light, and IR pixels 204 of one type as pixels sensitive to infrared light. However, in one embodiment, when obtaining a monochrome image of visible light, pixels sensitive to visible light suffice to be of only one type. The R pixel 201, the G pixel 202, and the B pixel 203 are examples of the first pixel sensitive to light of the first wavelength range, and the IR pixel 204 is an example of the second pixel sensitive to light of the second wavelength range different from the first wavelength range. The array of a plurality of pixels is not limited to the example shown in FIG. 2. For example, R pixels and B pixels may be alternately arranged on the first row, G pixels and IR pixels may be alternately arranged on the second row, and the first rows and the second rows may be alternately repeated.

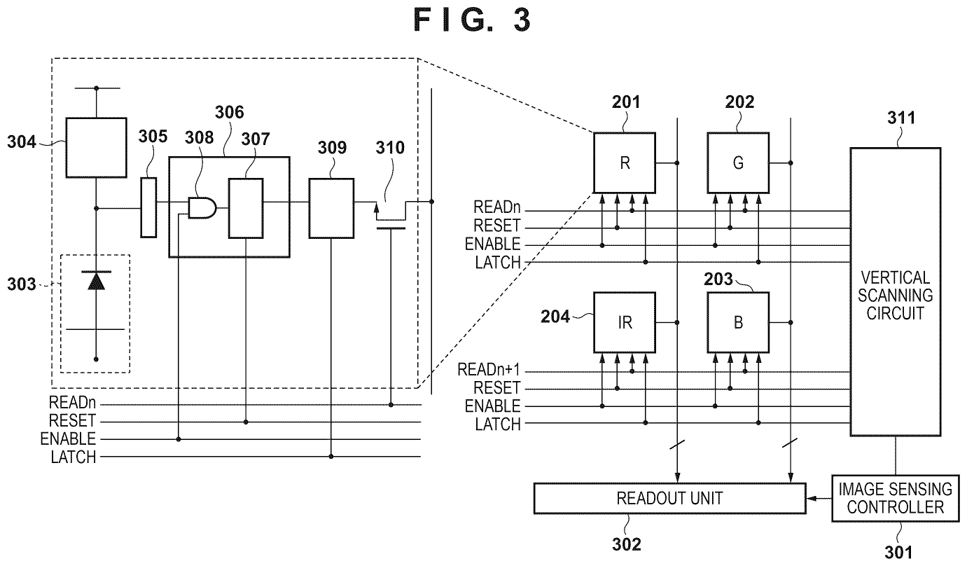

FIG. 3 shows the arrangement of the image sensor 102, and a detailed arrangement example of the pixels of the image sensor 102. The R pixel 201, the G pixel 202, and the B pixel 203 serving as pixels sensitive to visible light, and the IR pixel 204 serving as a pixel sensitive to infrared light can have the same circuit arrangement. The image sensor 102 can include, for example, an image sensing controller 301, a readout unit 302, and a vertical scanning circuit 311. FIG. 3 shows only four pixels, that is, the R pixel 201, the G pixel 202, the B pixel 203, and the IR pixel 204 as a plurality of pixels. The image sensing controller 301 controls each pixel via the vertical scanning circuit 311. A pixel value (digital data) obtained by each pixel is read out by the readout unit 302. The image sensing controller 301 sends various signals to the vertical scanning circuit 311 to control image sensing and readout. Also, the image sensing controller 301 sends a signal to the readout unit 302 to control readout.

The vertical scanning circuit 311 has an ENABLE signal, a RESET signal, a READn signal, and a LATCH signal as signals for controlling image sensing and readout of each pixel. The ENABLE signal is a signal that is asserted (activated) to enable the count operation of a counter 306 of each pixel. The RESET signal is a signal that is asserted to reset the count value (pixel value) of the counter 306 of each pixel. The LATCH signal is a signal that latches the count value of the counter 306 within the pixel in response to a signal transition (rise in this case). The READn signal is a signal provided every row, and is a signal that is asserted to output pixel values (digital data) to the readout unit 302 from the respective pixels of a corresponding row. The readout unit 302 sequentially outputs the pixel values (digital data) read out from the respective pixels to outside the image sensor 102.

Subsequently, details of each pixel will be explained. Each pixel can include, for example, an APD 303, a quench element 304, a waveform shaping unit 305, the counter 306, a latch circuit 309, and a selection transistor 310. The APD 303 is a photoelectric conversion unit, and when photons enter the APD 303, generates a charge pair corresponding to the incident light by photoelectric conversion. The first voltage can be supplied to the anode of the APD 303, and the second voltage higher than the first voltage can be supplied to the cathode of the APD 303. The charge pair generated by photoelectric conversion causes avalanche multiplication, generating an avalanche current. The quench element 304 connects the APD 303 and a power supply that supplies the second voltage, and converts a change of the avalanche current generated in the APD 303 into a voltage signal.

Further, the quench element 304 functions as a load circuit at the time of signal multiplication by avalanche multiplication, and stops the avalanche multiplication by suppressing the voltage supplied to the APD 303.

The waveform shaping unit 305 shapes a change of the potential of the cathode of the APD 303 when photons enter the APD 303, thereby generating a pulse signal. The counter 306 can operate upon receiving the pulse signal supplied from the waveform shaping unit 305, in addition to the ENABLE signal (enable signal) and the RESET signal (reset signal) supplied from the vertical scanning circuit 311. The counter 306 can include an AND circuit 308 as an enable circuit, and a counter circuit 307. When the waveform shaping unit 305 supplies a pulse in a case where the ENABLE signal is asserted and the RESET signal is deasserted, the count value of the counter circuit 307 is incremented. When the RESET signal is asserted, the count value of the counter circuit 307 is reset to a predetermined value.

The latch circuit 309 is a circuit that latches the count value of the counter 306 (counter circuit 307) in response to the leading edge of the LATCH signal (latch signal). The value latched by the latch circuit 309 is transmitted to the selection transistor 310 on a subsequent stage. When the READ signal (read signal) is asserted, the selection transistor 310 outputs the count value as a pixel value (digital data) to the readout unit 302 via a readout line. Each pixel maintains the pixel value even when the pixel value (digital data) is read out by the readout unit 302.

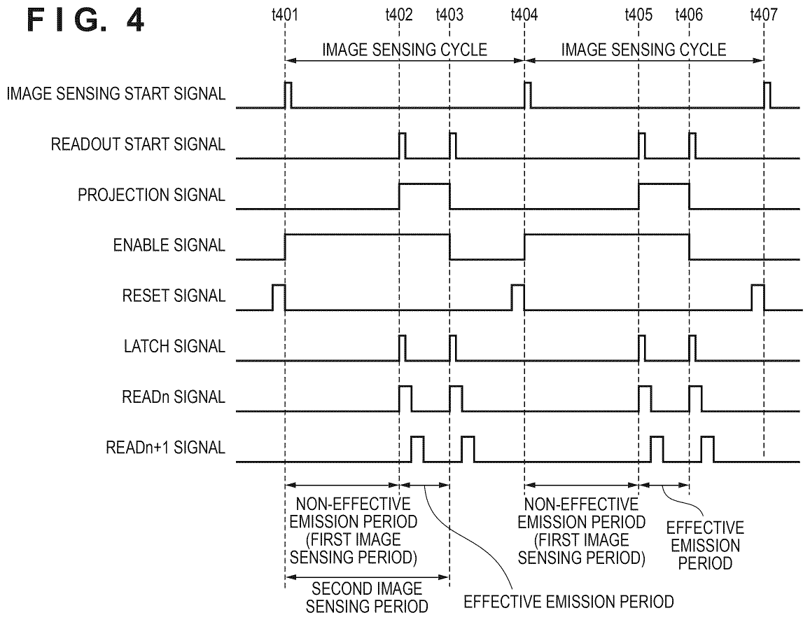

FIG. 4 exemplifies the operation of the image sensing system 100. The controller 104 outputs an image sensing start signal, a readout start signal, and a projection signal, and the vertical scanning circuit 311 outputs the ENABLE signal, the RESET signal, the LATCH signal, and the READ signal. The controller 104 can control the projector 103 by the projection signal so as to define an effective emission period in which the intensity of projection light is higher than a predetermined intensity, and a non-effective emission period in which the intensity of projection light is lower than the predetermined intensity. In this example, a period in which the projection signal is asserted is the effective emission period. The predetermined intensity is, for example, a target minimum intensity. A period in which even immediately after supply of a current to the light-emitting element of the projector 103 is cut off, the light-emitting element can slightly radiate light, but the intensity of light is lower than the predetermined intensity is the non-effective emission period.

The controller 104 or the vertical scanning circuit 311 controlled by the controller 104 defines the first image sensing period in which the R pixel 201, the G pixel 202, and the B pixel 203 serving as the first pixels perform image sensing. Further, the controller 104 or the vertical scanning circuit 311 controlled by the controller 104 defines the second image sensing period in which the IR pixel 204 serving as the second pixel performs image sensing. The image sensing period in which pixels perform image sensing can be understood as a period in which the pixels can reflect the number of incident photons as an output value in digital data. The first image sensing period in which the R pixel 201, the G pixel 202, and the B pixel 203 serving as the first pixels perform image sensing is a period including at least part of the non-effective emission period and not including the effective emission period. The second image sensing period in which the IR pixel serving as the second pixel performs image sensing is a period including at least part of the effective emission period and at least part of the non-effective emission period.

In the example shown in FIG. 4, the controller 104 defines the effective emission period and the non-effective emission period so that one image sensing cycle includes the non-effective emission period and the effective emission period subsequent to the non-effective emission period. In the example shown in FIG. 4, the first image sensing period is a period from the start to end of the non-effective emission period, and the second image sensing period is a period from the start of the non-effective emission period to the end of the effective emission period.

The latch circuit 309 of each of the plurality of pixels (first and second pixels) can perform a latch operation at the end of the first image sensing period, and perform the latch operation again at the end of the second image sensing period. As for the counter 306 of each of the plurality of pixels, reset can be canceled at the starts of the first and second image sensing periods, and the count operation can be enabled throughout the second image sensing period. The readout unit 302 reads out digital data from the latch circuits 309 of the R pixel 201, G pixel 202, and B pixel 203 serving as the first pixels after the end of the first image sensing period, and reads out digital data from the latch circuit 309 of the IR pixel 204 serving as the second pixel after the end of the second image sensing period.

A more detailed operation example of the image sensing system 100 will be explained below. At time t401, the controller 104 activates the image sensing start signal. The leading edge indicates the end and start of the image sensing cycle. Hence, the image sensing cycle that has started at time t401 ends in response to the leading edge of the image sensing start signal at time t404. Time t401 is also the start times of the first image sensing period, second image sensing period, and non-emission period within the image sensing cycle. In response to the leading edge of the image sensing start signal, the image sensing controller 301 transmits the image sensing start signal to the vertical scanning circuit 311. Then, the vertical scanning circuit 311 asserts the ENABLE signal in order to start image sensing in each pixel.

At time t402, the controller 104 activates the readout start signal. Here, the controller 104 activates the readout start signal so as to end the first image sensing period along with the lapse of the first predetermined period after activating the image sensing start signal. In response to the leading edge, the image sensing controller 301 transmits the readout start signal to the vertical scanning circuit 311 and the readout unit 302. Then, the vertical scanning circuit 311 activates the LATCH signal, and starts an operation of sequentially asserting the READn signals of a plurality of rows. In response to the leading edge of the LATCH signal, a pixel value (digital data) serving as the count value of the counter 306 is latched by the latch circuit 309 of each pixel, and the pixel values are read out from the pixels of a corresponding row in accordance with the assertion of the READn signal. At this time, the pixel value latched by the latch circuit 309 is maintained. In this state, the waveform shaping unit 305 generates a pulse signal in each pixel, and the counter 306 receives the pulse signal and increments the count value. The vertical scanning circuit 311 sequentially asserts the READn signals of a plurality of rows in a predetermined order, and the readout unit 302 sequentially reads out the pixel values of the plurality of rows. In response to the leading edge of the readout start signal, the controller 104 asserts the projection signal. In response to this, the projector 103 starts projecting projection light. Time t402 may be understood as the start time of the effective emission period.

At time t403, the controller 104 activates the readout start signal again. Here, the controller 104 activates the readout start signal so as to end the second image sensing period along with the lapse of the second predetermined period after activating the readout start signal at time t402. In response to the leading edge, the projection signal is deasserted, and the projector 103 ends the projection of projection light at time t403. The image sensing controller 301 transmits the readout start signal to the vertical scanning circuit 311 and the readout unit 302. Then, the vertical scanning circuit 311 activates the LATCH signal, and starts the operation of sequentially asserting the READn signals of a plurality of rows in a predetermined order. In response to the leading edge of the LATCH signal, a pixel value (digital data) serving as the count value of the counter 306 is latched by the latch circuit 309 of each pixel, and the pixel value is read out in accordance with the assertion of the READn signal. Note that rise of the LATCH signal and subsequent readout of the pixel value by assertion of the READn signal suffice to be completed by time t405 when the next readout starts, and may be executed in a period from time t403 to time t405.

At time t404, the controller 104 activates the image sensing start signal again. Here, the controller 104 activates the image sensing start signal so as to end one image sensing cycle that has started at time t401, along with the lapse of the third predetermined period after activating the readout start signal at time t403. Simultaneously when one image sensing cycle ends in response to the leading edge, the next image sensing cycle starts, as described above.

An operation from subsequent time t404 to time t407 is a repeat of the operation from time t401 to time t404.

The period from time t401 to time t402, the period from time t402 to time t403, and the period from time t403 to time t404 can be decided based on the setting of the image sensing cycle from time t401 to time t404. For example, it may be set that the image sensing cycle from time t401 to time t404 is 16.666 ms, the period from time t401 to time t402 is 15 ms, the period from time t402 to time t403 is 1 ms, and the period from time t403 to time t404 is 0.666 ms.

Alternatively, the above-described periods may be adjusted for each image sensing cycle in accordance with the image sensing environment and/or the implementation form of the image sensing system. For example, projection of projection light may be performed before reading out a visible light image as long as the visible light image is not influenced, or image sensing by the IR pixel 204 may continue even upon the lapse of the effective emission period as long as an S/N ratio requested of an infrared light image can be maintained.

The image sensing controller 301 may be understood as a control apparatus. The controller 104 can be configured to control an image sensor having a plurality of pixels arranged to constitute a plurality of rows and a plurality of columns. The plurality of pixels can include the first pixels (for example, the B pixels 203) and the second pixels (for example, the IR pixels 204) that belong to the same row, the first pixels can be sensitive to light of the first wavelength range, and the second pixels can be sensitive to light of the second wavelength range different from the first wavelength range. The image sensing controller 301 can be constituted to generate the first signal defining the image sensing period of the first pixel and the second signal defining the image sensing period of the second pixel in a period in which the signals of the first and second pixels are read out. In the example shown in FIG. 4, the first signal is a readout start signal that changes at time t402, and the second signal is a readout start signal that changes at time t403. The first signal defines the end of the image sensing period of the first pixel, and the second signal defines the end of the image sensing period of the second pixel.

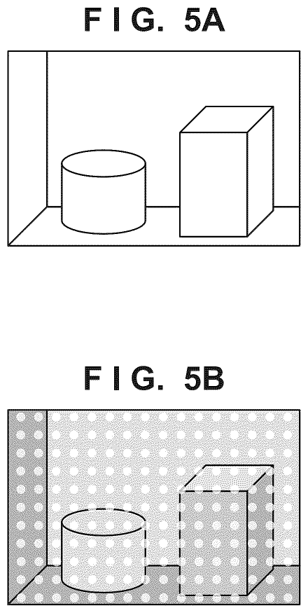

FIGS. 5A and 5B exemplify a visible light image (first image) and an infrared light image (second image) sensed in a given environment, respectively. FIG. 5A schematically shows a visible light image (first image) sensed by the first pixels (R pixel 201, G pixel 202, and B pixel 203) without projecting infrared light (projection light). FIG. 5B schematically shows an infrared light image (second image) sensed by projecting infrared light (projection light). When the environment is sufficiently bright, but infrared light is weak, an infrared light image becomes darker than a visible light image, like the image shown in FIG. 5B. However, the brightness and feature amount of the infrared light image can be increased by projecting infrared light. Note that FIG. 5B schematically shows an example in which projection light includes a dot pattern, and the shape of an object and the like present within the angle of view (field of view) are not considered. In actual, the dot pattern is arranged within an image in accordance with the shape of an object and the like.

According to the first embodiment, the image sensing system 100 obtains the first image (for example, an image of visible light) by performing image sensing by the first pixels without projecting projection light. In addition, the image sensing system 100 obtains the second image (for example, an image of infrared light and visible light) by performing image sensing by the second pixels in a state in which no projection light is projected and in a state in which projection light is projected. As a result, the influence of projection light is suppressed in the first image, whereas the S/N ratio can be improved in the second image by projecting projection light to increase the brightness.

### Second Embodiment

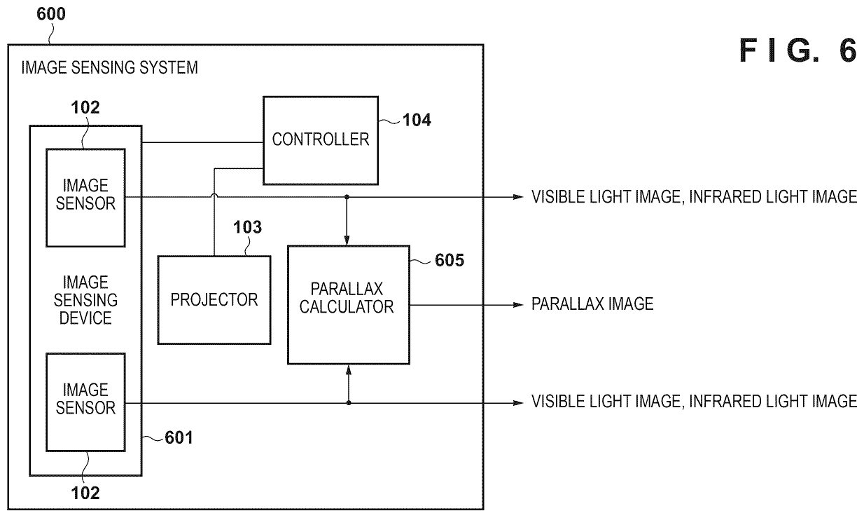

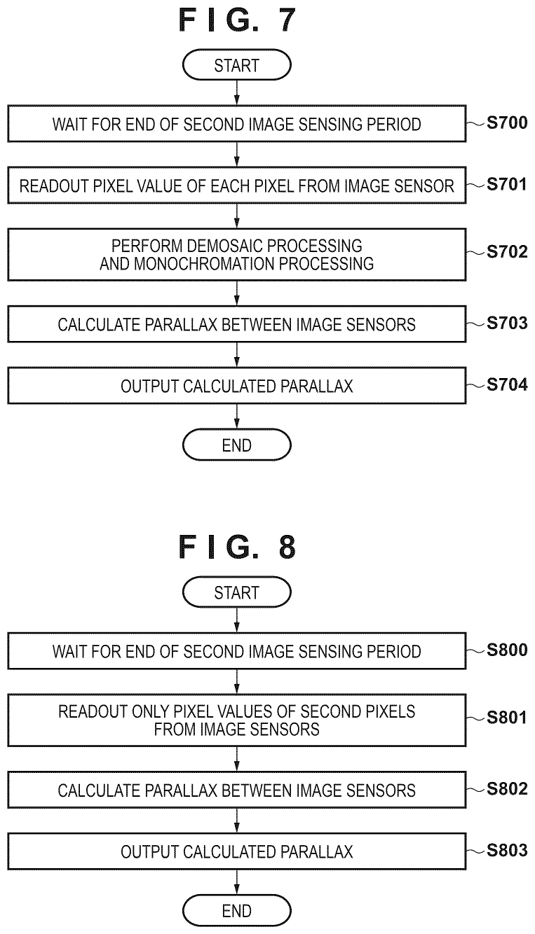

The second embodiment will be explained with reference to FIGS. 6 and 7. Matters which will not be mentioned in the second embodiment can be pursuant to the first embodiment. As for the arrangement and the operation described with reference to FIGS. 2 to 5, an image sensing system 600 according to the second embodiment is similar to the image sensing system 100 according to the first embodiment.

The image sensing system 600 according to the second embodiment calculates parallax by block matching based on a sensed image. Generally in block matching, an image of a large feature amount is more advantageous than an image of a small feature amount because parallax is calculated at a higher precision. In the second embodiment, therefore, parallax is calculated based on the second image (for example, an image of infrared light and visible light) in which the feature amount is increased by projecting projection light.

FIG. 6 shows the arrangement of the image sensing system 600 according to the second embodiment. In addition to a controller 104 and a projector 103, the image sensing system 600 according to the second embodiment includes an image sensing device 601 constituting a stereo camera, and a parallax calculation unit 605 that calculates parallax between stereo images sensed by the image sensing device 601.

The image sensing device 601 is a stereo camera in which two or more image sensing units are arranged at a predetermined distance. Each image sensing unit includes an image sensor 102, and an optical system (not shown) that forms an optical image of an image sensing target on the image sensing surface of the image sensor 102. The image sensor 102 can have an arrangement similar to that of the image sensor 102 described in the first embodiment. Two or more image sensors 102 basically perform the same operation synchronously, but need not always perform the same operation.

The parallax calculation unit 605 calculates parallax based on images output from the two or more image sensors 102. The calculated parallax can be output to outside the image sensing system 600 as a parallax image having a parallax value at a corresponding pixel position. As the calculation method, for example, Sum of Absolute Difference (SAD), Sum of Squared Difference (SSD), or semi-global matching can be employed.

FIG. 7 is a flowchart exemplifying a sequence of calculating parallax by the parallax calculation unit 605 in the image sensing system 600 according to the second embodiment. In step S700, the parallax calculation unit 605 waits for the end of the second image sensing period. In step S701, the parallax calculation unit 605 reads the first image and the second image that are read out respectively from a plurality of first pixels and a plurality of second pixels in each image sensor 102 by the controller 104. In step S702, the parallax calculation unit 605 performs demosaic processing and monochromation processing on the first and second images read in step S701. Since the image sensor 102 has IR pixels 204 as the second pixels, in addition to R pixels 201, G pixels 202, and B pixels 203 as the first pixels, demosaic processing and monochromation, in one embodiment, are performed with coefficients considering the sensitivities of the respective wavelength ranges. In step S703, the parallax calculation unit 605 calculates parallax for pixel values obtained after monochromation in step S702. In step S704, the parallax calculation unit 605 outputs the parallax calculated in step S703 to outside the image sensing system 600. The parallax calculation unit 605 may generate a parallax image based on one arbitrary image sensor 102 out of the two or more image sensors 102, or generate parallax images based on the two or more respective image sensors 102.

According to the second embodiment, the image sensing system according to the first embodiment is applied to a stereo camera, and parallax can be calculated using the first image in which the influence of projection light is suppressed, and the second image in which the S/N ratio is improved. The second embodiment is therefore advantageous for measuring a distance at high precision. The image sensing system 600 may be constituted by a single image sensor capable of obtaining an image plane phase difference.

### Third Embodiment

The third embodiment is a modification of the second embodiment. Matters which will not be mentioned in the third embodiment are pursuant to the second embodiment. The image sensing system 600 shown in FIG. 6 is employed in the third embodiment. An image sensing system 600 according to the third embodiment calculates parallax based on only the second image.

FIG. 8 is a flowchart exemplifying a sequence of calculating parallax by a parallax calculation unit 605 in the image sensing system 600 according to the third embodiment. In step S800, the parallax calculation unit 605 waits for the end of the second image sensing period. In step S801, the parallax calculation unit 605 reads the second image read out from second pixels in each image sensor 102 by a controller 104. In step S802, the parallax calculation unit 605 calculates parallax based on the second image read in step S801. In step S803, the parallax calculation unit 605 outputs the parallax calculated in step S802 to outside the image sensing system 600.

According to the third embodiment, parallax is calculated based on only the second image read out from the plurality of second pixels, so the parallax can be properly calculated by increasing the feature amount in the second wavelength range even for an object whose feature amount is small in the first wavelength range. Also, which of the parallax calculation method according to the second embodiment and the parallax calculation method according to the third embodiment is used may be decided based on the feature amount of a sensed first image. For example, when the feature amount of the first image is larger than a predetermined amount, the parallax calculation method according to the second embodiment may be used. When the feature amount of the first image is smaller than the predetermined amount, the parallax calculation method according to the third embodiment may be used.

### Fourth Embodiment

The fourth embodiment is a modification of the second embodiment. Matters which will not be mentioned in the fourth embodiment are pursuant to the second embodiment. The image sensing system 600 shown in FIG. 6 is employed in the fourth embodiment. An image sensing system 600 according to the fourth embodiment calculates parallax based on the first and second images.

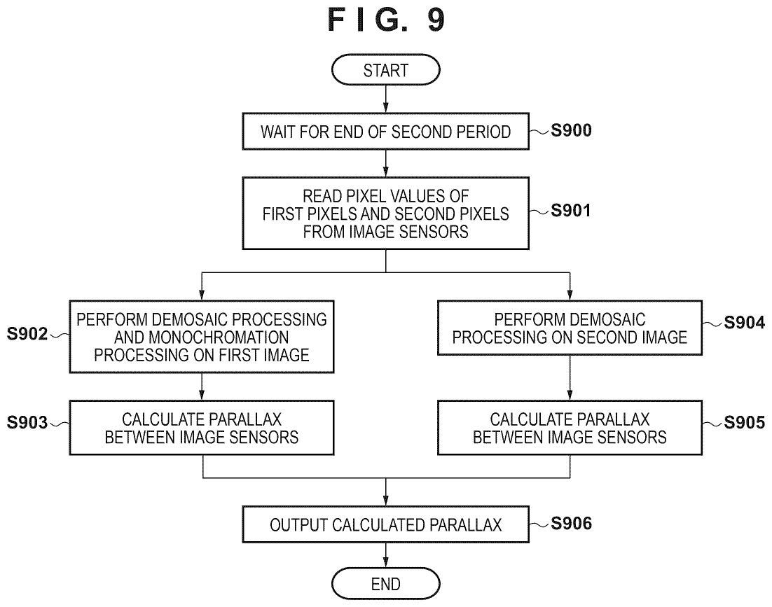

FIG. 9 is a flowchart exemplifying a sequence of calculating parallax by a parallax calculation unit 605 in the image sensing system 600 according to the fourth embodiment. In step S900, the parallax calculation unit 605 waits for the end of the second image sensing period. In step S901, the parallax calculation unit 605 reads the first image and the second image that are read out respectively from a plurality of first pixels and a plurality of second pixels in each image sensor 102 by a controller 104. In step S902, the parallax calculation unit 605 performs demosaic processing and monochromation processing on the first image read out in step S901.

In step S903, the parallax calculation unit 605 calculates parallax between the image sensors based on the first image having undergone monochromation in step S902. In step S904, the parallax calculation unit 605 performs demosaic processing on the second image read out in step S901. In step S905, the parallax calculation unit 605 calculates parallax between the image sensors based on the second image having undergone demosaic processing in step S904. In step S906, the parallax calculation unit 605 outputs the parallax values calculated in steps S903 and S905. Either of the processing constituted by steps S902 and S903 and the processing constituted by steps S904 and S905 may be executed first, or both of them may be executed in parallel.

According to the fourth embodiment, parallax is calculated based on the first image, and parallax is also calculated based on the second image. Similar to the second and third embodiments, while the influence of light of the second wavelength range on the first image is suppressed, a feature can be applied to even an object of a faint feature by light of the second wavelength range and parallax can be calculated at high precision. It is also possible to compare a parallax image based on the first image sensor and a parallax image based on the second image sensor from a parallax image based on the first image and a parallax image based on the second image that are output from the parallax calculation unit 605, select the value of a parallax image having a smaller parallax difference, and generate one parallax image. In this case, a parallax image higher in precision than parallax images calculated in the second and third embodiments can be obtained.

### Fifth Embodiment

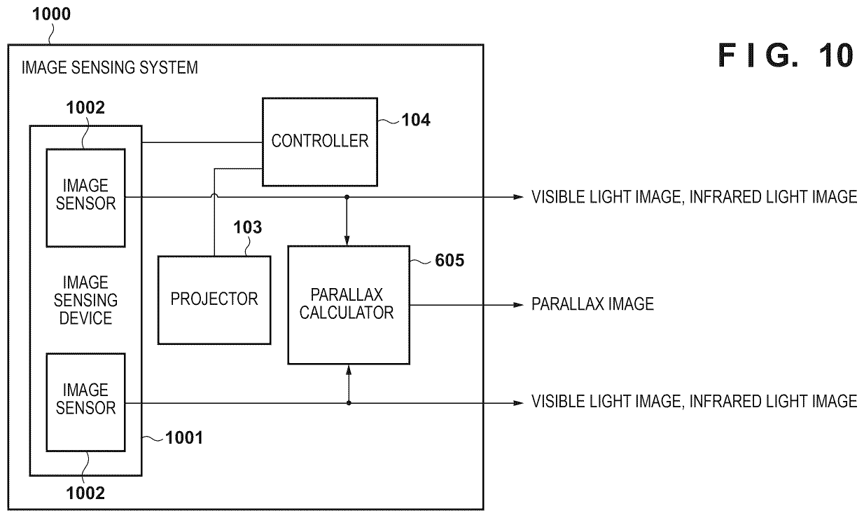

The fifth embodiment will be explained with reference to FIGS. 10, 11, and 12. Matters which will not be mentioned in the fifth embodiment can be pursuant to the first to fourth embodiments. Image sensors 1002 in an image sensing system 1000 according to the fifth embodiment can individually reset the first and second pixels.

FIG. 10 shows the arrangement of the image sensing system 1000 according to the fifth embodiment. In addition to a controller 104 and a projector 103, the image sensing system 1000 according to the fifth embodiment includes an image sensing device 1001 constituting a stereo camera, and a parallax calculation unit 605 that calculates parallax between stereo images sensed by the image sensing device 1001. The image sensing device 1001 is a stereo camera in which two or more image sensing units are arranged at a predetermined distance. Each image sensing unit includes the image sensor 1002, and an optical system (not shown) that forms an optical image of an image sensing target on the image sensing surface of the image sensor 1002. When the image sensing system 1000 is applied to a purpose in which no parallax is detected, the image sensor 1002 can be constituted by a single image sensing unit and the parallax calculation unit 605 can be eliminated.

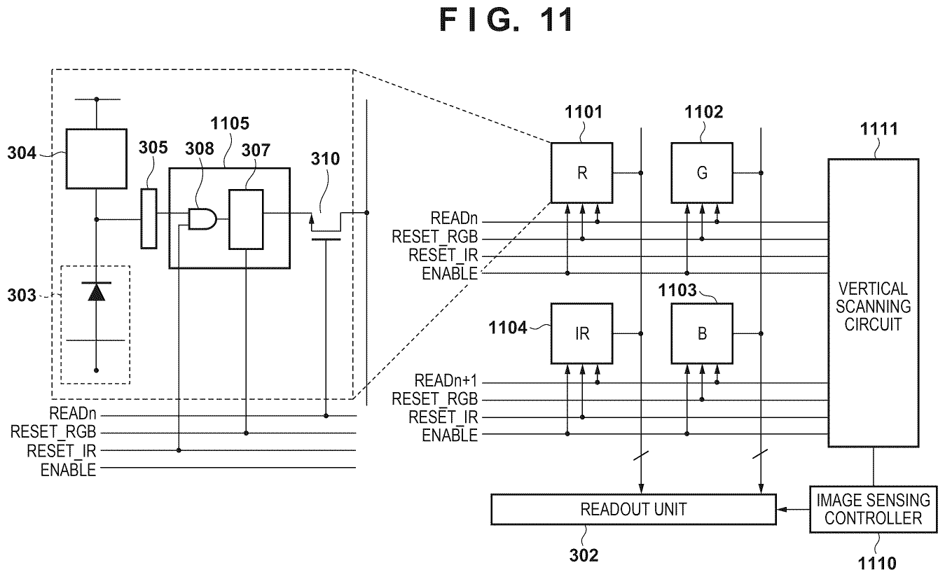

FIG. 11 shows the arrangement of the image sensor 1002, and a detailed arrangement example of the pixels of the image sensor 1002. A plurality of pixels of the image sensor 1002 include, for example, pixels of three types, more specifically, an R pixel 1101, a G pixel 1102, and a B pixel 1103 as pixels sensitive to visible light, and an IR pixel 1104 of one type as a pixel sensitive to infrared light. However, in one embodiment, when obtaining a monochrome image of visible light, pixels sensitive to visible light suffice to be of only one type. The R pixel 1101, the G pixel 1102, and the B pixel 1103 are examples of the first pixel sensitive to light of the first wavelength range, and the IR pixel 1104 is an example of the second pixel sensitive to light of the second wavelength range different from the first wavelength range.

The R pixel 1101, the G pixel 1102, and the B pixel 1103 serving as pixels sensitive to visible light, and the IR pixel 1104 serving as a pixel sensitive to infrared light can have the same circuit arrangement. The image sensor 1002 can include, for example, an image sensing controller 1110, a readout unit 302, and a vertical scanning circuit 1111. FIG. 11 shows only four pixels, that is, the R pixel 1101, the G pixel 1102, the B pixel 1103, and the IR pixel 1104 as a plurality of pixels. The image sensing controller 1110 controls each pixel via the vertical scanning circuit 1111. A pixel value (digital data) obtained by each pixel is read out by the readout unit 302. The image sensing controller 1110 sends various signals to the vertical scanning circuit 1111 to control image sensing and readout. Also, the image sensing controller 1110 sends a signal to the readout unit 302 to control readout.

The vertical scanning circuit 1111 has an ENABLE signal, a RESET_RGB signal, a RESET_IR signal, and a READn signal as signals for controlling image sensing and readout of each pixel. The ENABLE signal is a signal that is asserted (activated) to enable the count operation of a counter 1105 of each pixel. The RESET_RGB signal is a signal that is asserted to reset the count values of the counters 1105 of the R pixel 1101, G pixel 1102, and B pixel 1103 serving as the first pixels. The RESET_IR signal is a signal that is asserted to reset the count value of the counter 1105 of the IR pixel 1104 serving as the second pixel. Note that RESET signals respectively corresponding to the R pixel 1101, the G pixel 1102, and the B pixel 1103 may be so provided as to individually reset the counters 1105 of the R pixel 1101, G pixel 1102, and B pixel 1103 serving as the first pixels. The READn signal is a signal provided every row, and is a signal that is asserted to output pixel values (digital data) to the readout unit 302 from the respective pixels of a corresponding row. The readout unit 302 sequentially outputs the pixel values (digital data) read out from the respective pixels to outside the image sensor 1002.

Subsequently, details of each pixel will be explained. Each pixel can include, for example, an APD 303, a quench element 304, a waveform shaping unit 305, the counter 1105, and a selection transistor 310. The counter 1105 can include an AND circuit 308 as an enable circuit, and a counter circuit 307. The RESET_RGB signal is supplied to the counter circuits 307 of the R pixel 1101, G pixel 1102, and B pixel 1103 serving as the first pixels. The RESET_IR signal is supplied to the counter circuit 307 of the IR pixel 1104 serving as the second pixel.

In the counter circuits 307 of the R pixel 1101, G pixel 1102, and B pixel 1103, when the waveform shaping unit 305 supplies a pulse in a case where the ENABLE signal is asserted and the RESET_RGB signal is deasserted, the count value is incremented.

When the RESET_RGB signal is asserted, the count value of the counter circuit 307 is reset to a predetermined value. In the counter circuit 307 of the IR pixel 1104, when the waveform shaping unit 305 supplies a pulse in a case where the ENABLE signal is asserted and the RESET_IR signal is deasserted, the count value of the counter circuit 307 is incremented. When the RESET_IR signal is asserted, the count value of the counter circuit 307 is reset to a predetermined value.

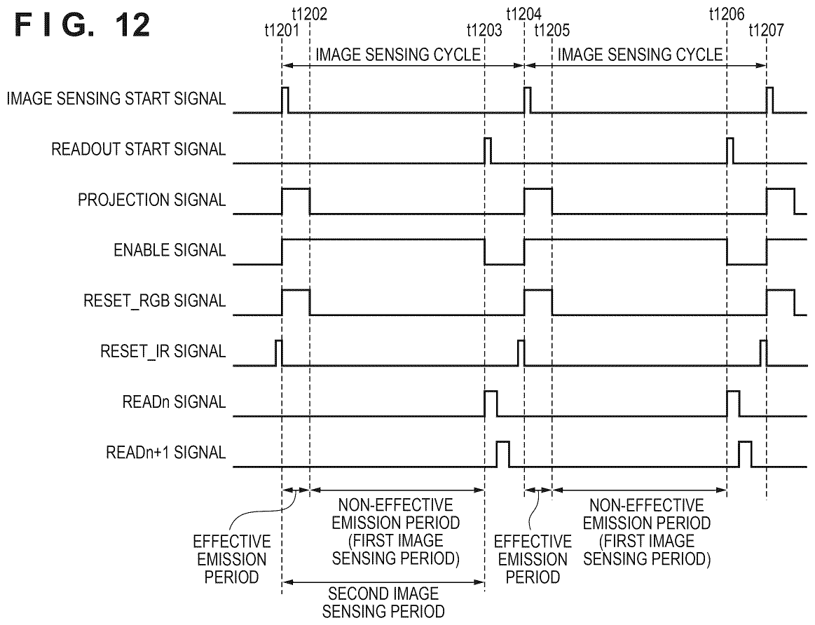

FIG. 12 exemplifies the operation of the image sensing system 1000. The controller 104 outputs an image sensing start signal, a readout start signal, and a projection signal, and the vertical scanning circuit 1111 outputs the ENABLE signal, the RESET_RGB signal, the RESET_IR signal, and the READn signal.

The controller 104 or the vertical scanning circuit 1111 controlled by the controller 104 defines the first image sensing period in which the R pixel 1101, the G pixel 1102, and the B pixel 1103 serving as the first pixels perform image sensing. In addition, the controller 104 or the vertical scanning circuit 1111 controlled by the controller 104 defines the second image sensing period in which the IR pixel 1104 serving as the second pixel performs image sensing. The image sensing period in which pixels perform image sensing can be understood as a period in which the pixels can generate digital data corresponding to the number of photons. The first image sensing period in which the R pixel 1101, the G pixel 1102, and the B pixel 1103 serving as the first pixels perform image sensing is a period including at least part of the non-effective emission period and not including the effective emission period. The second image sensing period in which the IR pixel serving as the second pixel performs image sensing is a period including at least part of the effective emission period and at least part of the non-effective emission period.

In the example shown in FIG. 12, the controller 104 defines the effective emission period and the non-effective emission period so that one image sensing cycle includes the effective emission period and the non-effective emission period subsequent to the effective emission period. In the example shown in FIG. 12, the first image sensing period starts at the start of the non-effective emission period and ends in the non-effective emission period, and the second image sensing period starts at the start of the effective emission period and ends in the non-effective emission period.

The count operation of the counters 1105 of the respective pixels (first and second pixels) can be enabled at the start of the second image sensing period and disabled at the end of the second image sensing period. The reset of the counters 1105 of the first pixels (R pixel 1101, G pixel 1102, and B pixel 1103) can be canceled at the start of the first image sensing period. The counters 1105 of the first pixels (R pixel 1101, G pixel 1102, and B pixel 1103) can be reset after readout of count values from all the first pixels ends. The reset of the counter 1105 of the second pixel (IR pixel 1104) can be canceled at the start of the second image sensing period. The counter 1105 of the second pixel (IR pixel 1104) can be reset after readout of count values from all the second pixels ends. The readout unit 302 reads out count values (digital data) serving as pixel values from the counters 1105 of the first and second pixels after the end of the first and second image sensing periods.

A more detailed operation example of the image sensing system 1000 will be explained below. At time t1201, the controller 104 activates the image sensing start signal. The leading edge indicates the end and start of the image sensing cycle. Hence, the image sensing cycle that has started at time t1201 ends in response to the leading edge of the image sensing start signal at time t1204. Time t1201 is also the start time of the second image sensing period within the image sensing cycle. In synchronization with the leading edge of the image sensing start signal, the controller 104 asserts a projection signal. In response to this, the projector 103 starts projecting projection light. Time t1201 may be understood as the start time of the effective emission period. In the effective emission period, the image sensing device 1001 performs image sensing by the IR pixel 1104 serving as the second pixel, but does not perform image sensing by the R pixel 1101, the G pixel 1102, and the B pixel 1103 serving as the first pixels. Thus, the vertical scanning circuit 1111 deasserts the RESET_IR signal at time t1201 and asserts the reset signal RESET_RGB.

At time t1202, the controller 104 deasserts the projection signal. Here, the controller 104 deasserts the projection signal along with the lapse of the first predetermined period after activating the image sensing start signal at time t1201. In response to this, the projector 103 ends the projection of projection light. To start image sensing by the first pixels in response to the end of projection of projection light, the vertical scanning circuit 1111 deasserts the reset RESET_RGB signals of the counters 1105 of the R pixel 1101, G pixel 1102, and B pixel 1103.

At time t1203, the controller 104 activates the readout start signal. Here, the controller 104 activates the readout start signal so as to end the first and second image sensing periods along with the lapse of the second predetermined period after deasserting the projection signal at time t1202. In response to the leading edge, the vertical scanning circuit 1111 deasserts the ENABLE signal to end image sensing, and starts an operation of sequentially asserting the READn signals of a plurality of rows. In response to the assertion of the READn signal, pixel values are read out from the pixels of a corresponding row. The vertical scanning circuit 1111 asserts the RESET_IR signal at least once in a period from time t1203 to time t1204.

At time t1204, the controller 104 activates the image sensing start signal again. Here, the controller 104 activates the image sensing start signal so as to end the image sensing cycle along with the lapse of the third predetermined period after activating the readout start signal at time t1203.

A period from subsequent time t1204 to time t1207 is a repeat of the operation from time t1201 to time t1204.

In the fifth embodiment, reset of the first pixels and reset of the second pixels are individually canceled.

More specifically, reset of the second pixels is canceled, and image sensing by the second pixels is performed while projection light is projected. Then, the projection of projection light is ended, reset of the first pixels is canceled, and image sensing by the first pixels is started. In the first image obtained by image sensing by the first pixels, the influence of projection light is suppressed. In the second image obtained by image sensing by the second pixels, the S/N ratio can be improved by projecting projection light to increase the brightness. Since pixel values can be read out in parallel from the first and second pixels, speeding-up and reduction of power consumption can be achieved.

### Sixth Embodiment

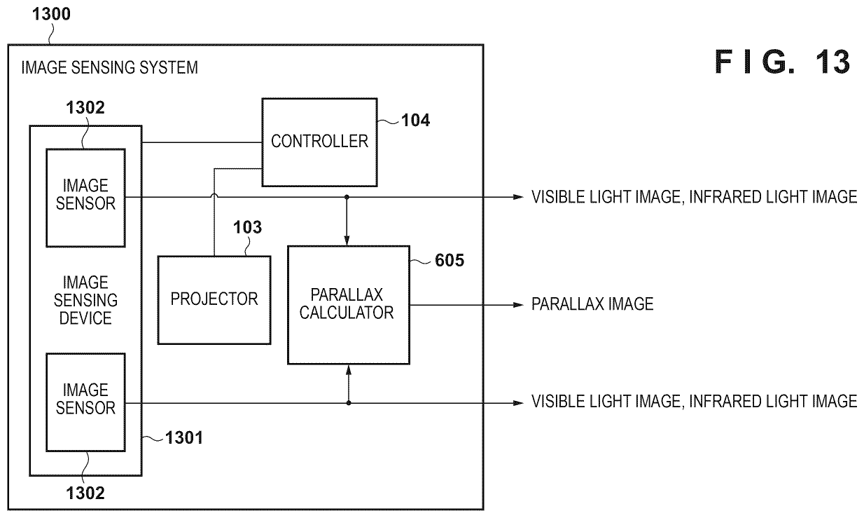

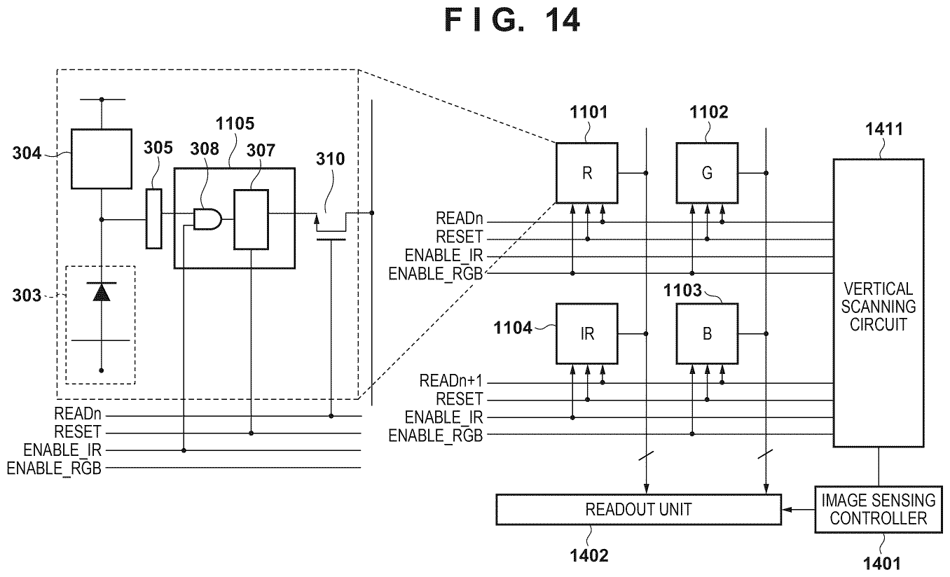

The sixth embodiment will be explained with reference to FIGS. 13, 14, and 15. Matters which will not be mentioned in the sixth embodiment can be pursuant to the first to fifth embodiments. Image sensors 1302 in an image sensing system 1300 according to the sixth embodiment can individually enable the first and second pixels.

FIG. 13 shows the arrangement of the image sensing system 1300 according to the sixth embodiment. In addition to a controller 104 and a projector 103, the image sensing system 1300 according to the sixth embodiment includes an image sensing device 1301 constituting a stereo camera, and a parallax calculation unit 605 that calculates parallax between stereo images sensed by the image sensing device 1301. The image sensing device 1301 is a stereo camera in which two or more image sensing units are arranged at a predetermined distance. Each image sensing unit includes the image sensor 1302, and an optical system (not shown) that forms an optical image of an image sensing target on the image sensing surface of the image sensor 1302. When the image sensing system 1300 is applied to a purpose in which no parallax is detected, the image sensor 1302 can be constituted by a single image sensing unit and the parallax calculation unit 605 can be eliminated.

FIG. 14 shows the arrangement of the image sensor 1302, and a detailed arrangement example of the pixels of the image sensor 1302. A plurality of pixels of the image sensor 1302 include, for example, pixels of three types, more specifically, an R pixel 1101, a G pixel 1102, and a B pixel 1103 as pixels sensitive to visible light, and an IR pixel 1104 of one type as a pixel sensitive to infrared light. However, in one embodiment, when obtaining a monochrome image of visible light, pixels sensitive to visible light suffice to be of only one type. The R pixel 1101, the G pixel 1102, and the B pixel 1103 are examples of the first pixel sensitive to light of the first wavelength range, and the IR pixel 1104 is an example of the second pixel sensitive to light of the second wavelength range different from the first wavelength range.

The R pixel 1101, the G pixel 1102, and the B pixel 1103 serving as pixels sensitive to visible light, and the IR pixel 1104 serving as a pixel sensitive to infrared light can have the same circuit arrangement. The image sensor 1302 can include, for example, an image sensing controller 1401, a readout unit 1402, and a vertical scanning circuit 1411. FIG. 14 shows only four pixels, that is, the R pixel 1101, the G pixel 1102, the B pixel 1103, and the IR pixel 1104 as a plurality of pixels. The image sensing controller 1401 controls each pixel via the vertical scanning circuit 1411. A pixel value (digital data) obtained by each pixel is read out by the readout unit 1402. The image sensing controller 1401 sends various signals to the vertical scanning circuit 1411 to control image sensing and readout. Also, the image sensing controller 1401 sends a signal to the readout unit 1402 to control readout.

The vertical scanning circuit 1411 has an ENABLE_RGB signal, an ENABLE_IR signal, a RESET signal, and a READn signal as signals for controlling image sensing and readout of each pixel.

The ENABLE_RGB signal is a signal that is asserted (activated) to enable the count operation of counters 1105 of the R pixel 1101, G pixel 1102, and B pixel 1103 serving as the first pixels. The ENABLE_IR signal is a signal that is asserted (activated) to enable the count operation of the counter 1105 of the IR pixel 1104 serving as the second pixel. The RESET signal is a signal that is asserted to reset the count value of the counter 1105 of each pixel. Note that ENABLE signals respectively corresponding to the R pixel 1101, the G pixel 1102, and the B pixel 1103 may be so provided as to individually enable the counter operations of the counters 1105 of the R pixel 1101, G pixel 1102, and B pixel 1103 serving as the first pixels. The READn signal is a signal provided every row, and is a signal that is asserted to output pixel values (digital data) to the readout unit 1402 from the respective pixels of a corresponding row. The readout unit 1402 sequentially outputs the pixel values (digital data) read out from the respective pixels to outside the image sensor 1302.

The vertical scanning circuit 1411 may assert only the READn signal of a row including a specific pixel in accordance with a signal at the time of readout from the image sensing controller 1401. In one embodiment, the readout unit 1402 may output only the pixel value of a column including a specific pixel in accordance with a signal at the time of readout from the image sensing controller 1401.

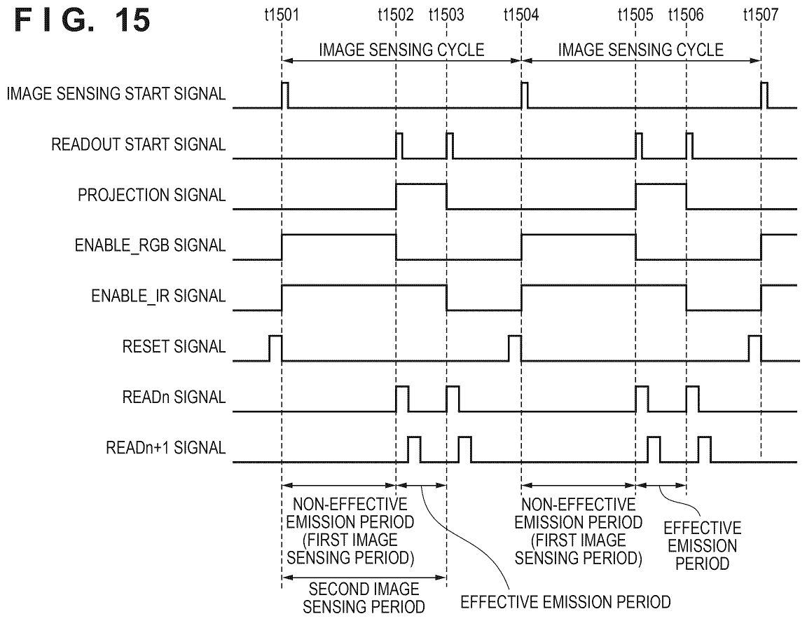

FIG. 15 exemplifies the operation of the image sensing system 1300. The controller 104 outputs an image sensing start signal, a readout start signal, and a projection signal, and the vertical scanning circuit 1411 outputs the ENABLE_RGB signal, the ENABLE_IR signal, the RESET signal, and the READn signal.

The controller 104 or the vertical scanning circuit 1411 controlled by the controller 104 defines the first image sensing period in which the R pixel 1101, the G pixel 1102, and the B pixel 1103 serving as the first pixels perform image sensing. Also, the controller 104 or the vertical scanning circuit 1411 controlled by the controller 104 defines the second image sensing period in which the IR pixel 1104 serving as the second pixel performs image sensing. The image sensing period in which pixels perform image sensing can be understood as a period in which the pixels can generate digital data corresponding to the number of photons. The first image sensing period in which the R pixel 1101, the G pixel 1102, and the B pixel 1103 serving as the first pixels perform image sensing is a period including at least part of the non-effective emission period and not including the effective emission period. The second image sensing period in which the IR pixel 1104 serving as the second pixel performs image sensing is a period including at least part of the effective emission period and at least part of the non-effective emission period.

In the example shown in FIG. 15, the controller 104 defines the effective emission period and the non-effective emission period so that one image sensing cycle includes the non-effective emission period and the effective emission period subsequent to the non-effective emission period. In the example shown in FIG. 15, the first image sensing period is a period from the start to end of the non-effective emission period, and the second image sensing period starts at the start of the non-effective emission period and ends in the effective emission period.

The reset of the counters 1105 of the respective pixels (first and second pixels) can be canceled at the start of the second image sensing period. The count operation of the counters 1105 of the first pixels (R pixel 1101, G pixel 1102, and B pixel 1103) can be enabled at the start of the first image sensing period and disabled at the end of the first image sensing period. The count operation of the counter 1105 of the second pixel (IR pixel 1104) can be enabled at the start of the second image sensing period and disabled at the end of the second image sensing period. The readout unit 1402 reads out count values serving as pixel values from the counters 1105 of the first pixels after the end of the first image sensing period, thereby reading out digital data. The readout unit 1402 reads out a count value serving as a pixel value from the counter 1105 of the second pixel after the end of the second image sensing period.

A more detailed operation example of the image sensing system 1300 will be explained below. At time t1501, the controller 104 activates the image sensing start signal. The leading edge indicates the end and start of the image sensing cycle. The image sensing cycle that has started at time t1501 ends in response to the leading edge of the image sensing start signal at time t1504. Time t1501 is also the start times of the first and second image sensing periods within the image sensing cycle. In response to the leading edge of the image sensing start signal, the image sensing controller 1401 transmits the image sensing start signal to the vertical scanning circuit 1411. Then, the vertical scanning circuit 1411 asserts the ENABLE_RGB signal and the ENABLE_IR signal to start image sensing by the first and second pixels.

At time t1502, the controller 104 activates the readout signal. The controller 104 activates the readout start signal so as to end the first image sensing period along with the lapse of the first predetermined period after activating the image sensing start signal. In response to the leading edge, the image sensing controller 1401 transmits the readout start signal to the vertical scanning circuit 1411 and the readout unit 1402. Then, the vertical scanning circuit 1411 deasserts the ENABLE_RGB signal, and starts an operation of sequentially asserting the READn signals of a plurality of rows. In response to the assertion of the READn signal, pixel values are read out from the pixels of a corresponding row while the count values of the counters 1105 of the R pixel 1101, G pixel 1102, and B pixel 1103 serving as the first pixels are maintained. Since the ENABLE_IR signal remains asserted, image sensing by the IR pixel 1104 serving as the second pixel continues. The vertical scanning circuit 1411 asserts the READn signals of respective rows in a predetermined order, thereby reading out the pixel values of the respective rows. At this time, in one embodiment, the vertical scanning circuit 1411 may read out pixel values of only a row including a specific pixel in accordance with a signal from the image sensing controller 1401. Also, the readout unit 1402 may read out pixel values of only a column including a specific pixel in accordance with a signal from the image sensing controller 1401.

Also, at time t1502, the controller 104 asserts the projection signal after activating the readout start signal. In response to this, the projector 103 starts projecting projection light. At time t1503, the controller 104 activates the readout start signal again. Here, the controller 104 activates the readout start signal so as to end the second image sensing period along with the lapse of the second predetermined period after activating the readout start signal at time t1502. In response to the leading edge, the vertical scanning circuit 1411 deasserts the ENABLE_IR signal to end image sensing by the second pixel, and starts an operation of sequentially asserting the READn signals of a plurality of rows. In response to the assertion of the READn signal, pixel values are read out from pixels of a corresponding row. The vertical scanning circuit 1411 asserts the READn signal of each row, thereby reading out the pixel value of the row. In one embodiment, at this time, the vertical scanning circuit 1411 may read out pixel values of only a row including a specific pixel in accordance with a signal from the image sensing controller 1401. Also, the readout unit 1402 may read out pixel values of only a column including a specific pixel in accordance with a signal from the image sensing controller 1401. At time t1503, the controller 104 deasserts the projection signal, and the projector 103 stops the projection of projection light in response to this.

At time t1504, the controller 104 activates the image sensing start signal again. The controller 104 activates the image sensing start signal so as to end one image sensing cycle that has started at time t1501, along with the lapse of the third predetermined period after activating the readout start signal at time t1503. Simultaneously when one image sensing cycle ends in response to the leading edge, the next image sensing cycle starts, as described above.

An operation from subsequent time t1504 to time t1507 is a repeat of the operation from time t1501 to time t1504.

According to the sixth embodiment, the first and second images can be obtained by individually enabling the count operation of the first pixels and that of the second pixels while eliminating a latch circuit. In one embodiment, pixel values can be read out from only the first pixels by the vertical scanning circuit 1411 and the readout unit 1402 in order to obtain the first image, and/or pixel values can be read out from only the second pixels by the vertical scanning circuit 1411 and the readout unit 1402 in order to obtain the second image. This can achieve speeding-up and reduction of power consumption.

### Seventh Embodiment

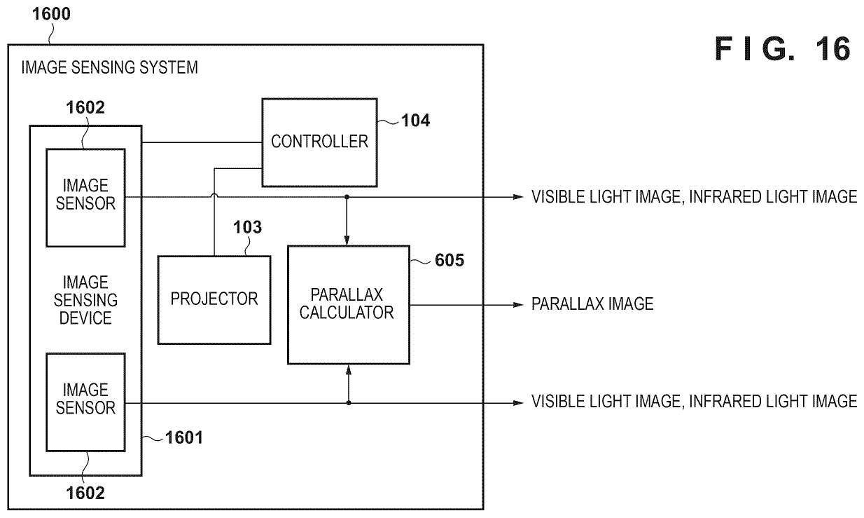

The seventh embodiment will be explained with reference to FIGS. 16, 17, and 18. Matters which will not be mentioned in the seventh embodiment can be pursuant to the first to sixth embodiments. In an image sensing system 1600 according to the seventh embodiment, an image sensor that controls pixels for each row is employed instead of the image sensor in each of the image sensing systems according to the first, fifth, and sixth embodiments.

FIG. 16 shows the arrangement of the image sensing system 1600 according to the seventh embodiment. In addition to a controller 104 and a projector 103, the image sensing system 1600 according to the seventh embodiment includes an image sensing device 1601 constituting a stereo camera, and a parallax calculation unit 605 that calculates parallax between stereo images sensed by the image sensing device 1601. The image sensing device 1601 is a stereo camera in which two or more image sensing units are arranged at a predetermined distance. Each image sensing unit includes an image sensor 1602, and an optical system (not shown) that forms an optical image of an image sensing target on the image sensing surface of the image sensor 1602. When the image sensing system 1600 is applied to a purpose in which no parallax is detected, the image sensor 1602 can be constituted by a single image sensing unit and the parallax calculation unit 605 can be eliminated.

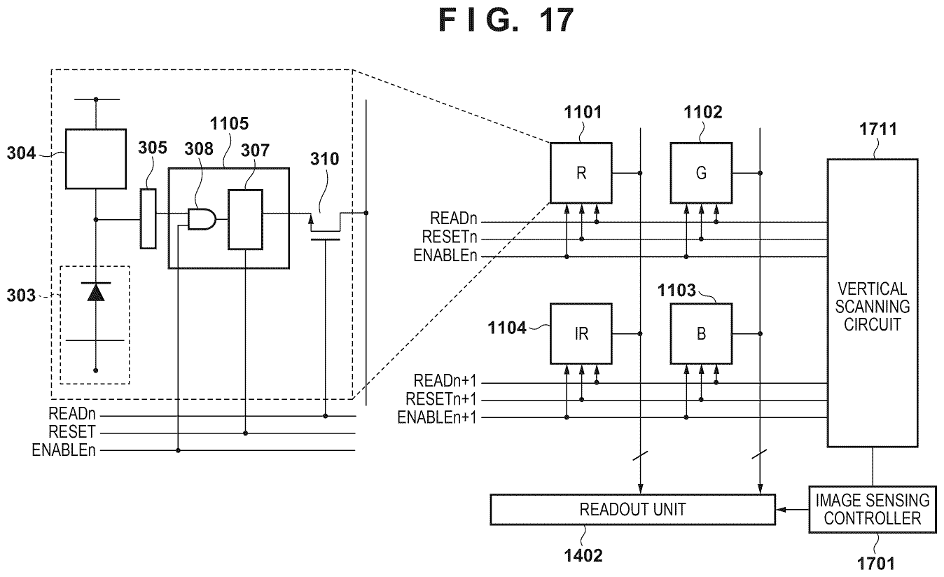

FIG. 17 shows the arrangement of the image sensor 1602, and a detailed arrangement example of the pixels of the image sensor 1602. A plurality of pixels of the image sensor 1602 include, for example, pixels of three types, more specifically, an R pixel 1101, a G pixel 1102, and a B pixel 1103 as pixels sensitive to visible light, and an IR pixel 1104 of one type as a pixel sensitive to infrared light. However, in one embodiment, when obtaining a monochrome image of visible light, pixels sensitive to visible light suffice to be of only one type. The R pixel 1101, the G pixel 1102, and the B pixel 1103 are examples of the first pixel sensitive to light of the first wavelength range, and the IR pixel 1104 is an example of the second pixel sensitive to light of the second wavelength range different from the first wavelength range.

The R pixel 1101, the G pixel 1102, and the B pixel 1103 serving as pixels sensitive to visible light, and the IR pixel 1104 serving as a pixel sensitive to infrared light can have the same circuit arrangement. The image sensor 1602 can include, for example, an image sensing controller 1701, a readout unit 1402, and a vertical scanning circuit 1711. FIG. 17 shows only four pixels, that is, the R pixel 1101, the G pixel 1102, the B pixel 1103, and the IR pixel 1104 as a plurality of pixels. The image sensing controller 1701 controls each pixel via the vertical scanning circuit 1711. A pixel value (digital data) obtained by each pixel is read out by the readout unit 1402. The image sensing controller 1701 sends various signals to the vertical scanning circuit 1711 to control image sensing and readout. Also, the image sensing controller 1701 sends a signal to the readout unit 1402 to control readout.

The vertical scanning circuit 1711 has an ENABLEn signal, a RESETn signal, and a READn signal as signals for controlling image sensing and readout of each pixel. The ENABLEn signal is a signal that is asserted (activated) to enable the count operation of counters 1105 of the respective pixels of the nth row to which the ENABLEn signal is supplied. The RESETn signal is a signal that is asserted to reset the count values of the counters 1105 of the respective pixels of the nth row to which the RESETn signal is supplied. The READn signal is a signal that is asserted to output pixel values (digital data) to the readout unit 1402 from the respective pixels of the nth row to which the READn signal is supplied.

The readout unit 1402 sequentially outputs the pixel values (digital data) read out from the respective pixels to outside the image sensor 1602.

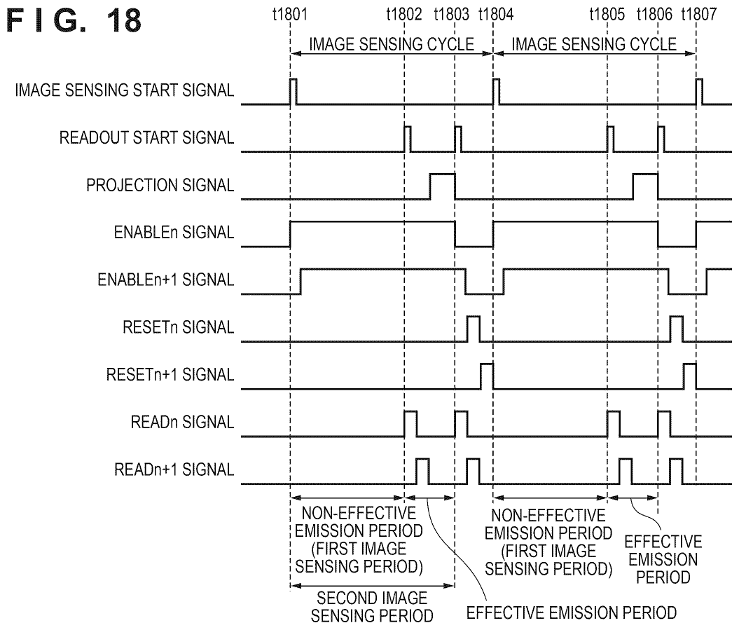

FIG. 18 exemplifies the operation of the image sensing system 1600. The controller 104 outputs an image sensing start signal, a readout start signal, and a projection signal, and the vertical scanning circuit 1711 outputs the ENABLEn signal, the RESETn signal, and the READn signal.

The controller 104 or the vertical scanning circuit 1711 controlled by the controller 104 defines the first image sensing period in which the R pixel 1101, the G pixel 1102, and the B pixel 1103 serving as the first pixels perform image sensing. Further, the controller 104 or the vertical scanning circuit 1711 controlled by the controller 104 defines the second image sensing period in which the IR pixel 1104 serving as the second pixel performs image sensing. The image sensing period in which pixels perform image sensing can be understood as a period in which the pixels can generate digital data corresponding to the number of photons.

In the example shown in FIG. 18, the controller 104 defines the effective emission period and the non-effective emission period so that one image sensing cycle includes the non-effective emission period and the effective emission period subsequent to the non-effective emission period. The first image sensing period in which the first pixels (R pixel 1101, G pixel 1102, and B pixel 1103) perform image sensing is a period until readout of pixel values (digital data) from the counters 1105 of the first pixels starts after the counters 1105 of the first pixels are enabled. The second image sensing period in which the second pixel (IR pixel 1104) performs image sensing is a period until readout of a pixel value (digital data) from the counter 1105 of the second pixel starts after the counter 1105 of the second pixel is enabled. The effective emission period starts after readout of pixel values from the counters 1105 of the plurality of first pixels (all the first pixels from which pixel values are read out), and ends before readout of pixel values from the counters 1105 of the plurality of second pixels.

A more detailed operation example of the image sensing system 1600 will be explained below. At time t1801, the controller 104 activates the image sensing start signal. The leading edge indicates the end and start of the image sensing cycle. The image sensing cycle that has started at time t1801 ends in response to the leading edge of the image sensing start signal at time t1804. Time t1801 is also the start times of the first and second image sensing periods within the image sensing cycle. In response to the leading edge of the image sensing start signal, the image sensing controller 1701 transmits the image sensing start signal to the vertical scanning circuit 1711. To start image sensing by each pixel, the vertical scanning circuit 1711 starts an operation of sequentially asserting the ENABLEn signals of a plurality of rows in a predetermined order. The assertion of the ENABLEn signals of a plurality of rows need not always be executed at equal intervals, but is executed at equal intervals.

At time t1802, the controller 104 activates the readout start signal. Here, the controller 104 activates the readout start signal so as to end the first image sensing period along with the lapse of the first predetermined period after activating the image sensing start signal. In response to the leading edge, the image sensing controller 1701 transmits the readout start signal to the vertical scanning circuit 1711 and the readout unit 1402. Then, the vertical scanning circuit 1711 starts an operation of sequentially asserting the READn signals of a plurality of rows in a predetermined order. Although pixel values are read out by the assertion of the READn signal, the values of the counters 1105 are maintained. In this state, if a waveform shaping unit 305 generates a pulse signal, the counter 1105 receives it and increments the count value. The vertical scanning circuit 1711 sequentially asserts the READn signals of a plurality of rows in a predetermined order, thereby sequentially reading out the pixel values of the plurality of rows by the readout unit 1402.

In one embodiment, the assertion of the READn signals of a plurality of rows is performed in the same order as that of assertion of ENABLEn signals that define the starts of image sensing of a plurality of rows which has started from time t1801, but is not always limited to this. Upon completion of readout of the pixels of the plurality of rows in response to the leading edge of the readout start signal at time t1802, the controller 104 asserts the projection signal, and the projector 103 projects projection light.

At time t1803, the controller 104 activates the readout start signal again. Here, the controller 104 activates the readout start signal so as to end the second image sensing period along with the lapse of the second predetermined period after activating the readout start signal at time t1802. In response to the leading edge, the image sensing controller 1701 transmits the readout start signal to the vertical scanning circuit 1711 and the readout unit 1402. Then, the vertical scanning circuit 1711 starts an operation of sequentially asserting the READn signals of a plurality of rows in a predetermined order. In response to the transmission of the readout start signal, the vertical scanning circuit 1711 performs an operation of sequentially deasserting the ENABLE signals of a plurality of rows, and performs assertion and deassertion (that is, reset) of the RESETn signals of a plurality of rows.

The vertical scanning circuit 1711 may read out pixel values of a row including a specific pixel in accordance with a signal from the image sensing controller 1701. Also, the readout unit 1402 may read out pixel values of a column including a specific pixel in accordance with a signal from the image sensing controller 1401. It is enough to complete deassertion of the RESET signal of each row until the ENABLE signal of each row is asserted from time t1804. Deassertion of the RESET signal may be performed from time t1804.

At time t1804, the controller 104 activates the image sensing start signal again. The controller 104 activates the image sensing start signal so as to end one image sensing cycle that has started at time t1801, along with the lapse of the third predetermined period after activating the readout start signal at time t1803. Simultaneously when one image sensing cycle ends in response to the leading edge, the next image sensing cycle starts, as described above.

An operation from subsequent time t1804 to time t1807 is a repeat of the operation from time t1801 to time t1804.

According to the seventh embodiment, effects similar to those in the first, fifth, and sixth embodiments can be obtained in the method of controlling a plurality of pixels of an image sensor for each row. In one embodiment, pixel values can be read out from only the first pixels by the vertical scanning circuit 1711 and the readout unit 1402 in order to obtain the first image, and/or pixel values can be read out from only the second pixels by the vertical scanning circuit 1711 and the readout unit 1402 in order to obtain the second image. This can achieve speeding-up and reduction of power consumption.

### Eighth Embodiment

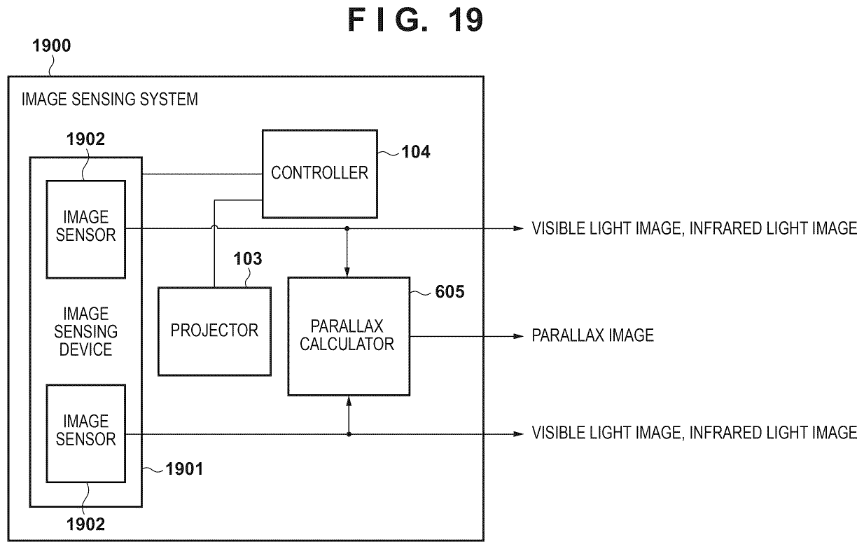

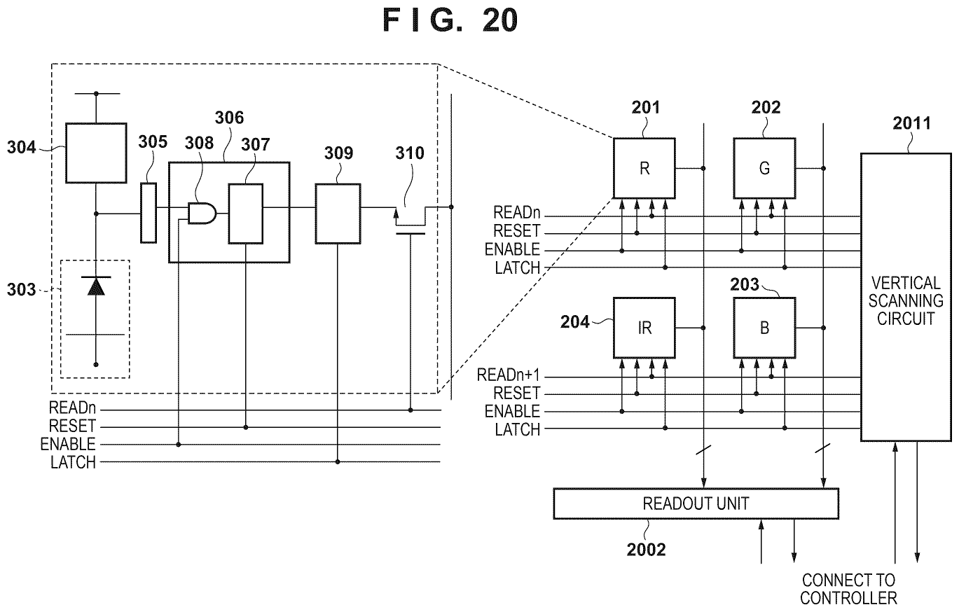

The eighth embodiment will be explained with reference to FIGS. 19 and 20. Matters which will not be mentioned in the eighth embodiment can be pursuant to the first to seventh embodiments. In an image sensing system 1900 according to the eighth embodiment, the image sensing controller of an image sensor in each of the image sensing systems according to the first, fifth, sixth, and seventh embodiments is provided outside the image sensor.

FIG. 19 shows the arrangement of the image sensing system 1900 according to the eighth embodiment. In addition to a controller 1904 and a projector 103, the image sensing system 1900 according to the eighth embodiment includes an image sensing device 1901 constituting a stereo camera, and a parallax calculation unit 605 that calculates parallax between stereo images sensed by the image sensing device 1901. The image sensing device 1901 is a stereo camera in which two or more image sensing units are arranged at a predetermined distance. Each image sensing unit includes an image sensor 1902, and an optical system (not shown) that forms an optical image of an image sensing target on the image sensing surface of the image sensor 1902. When the image sensing system 1900 is applied to a purpose in which no parallax is detected, the image sensing device 1901 can be constituted by a single image sensing unit and the parallax calculation unit 605 can be eliminated.

FIG. 20 shows the arrangement of the image sensor 1902, and a detailed arrangement example of the pixels of the image sensor 1902. A plurality of pixels of the image sensor 1902 include, for example, pixels of three types, more specifically, an R pixel 201, a G pixel 202, and a B pixel 203 as pixels sensitive to visible light, and an IR pixel 204 of one type as a pixel sensitive to infrared light. However, in one embodiment, when obtaining a monochrome image of visible light, pixels sensitive to visible light suffice to be of one type. The R pixel 201, the G pixel 202, and the B pixel 203 are examples of the first pixel sensitive to light of the first wavelength range, and the IR pixel 204 is an example of the second pixel sensitive to light of the second wavelength range different from the first wavelength range.

The R pixel 201, the G pixel 202, and the B pixel 203 serving as pixels sensitive to visible light, and the IR pixel 204 serving as a pixel sensitive to infrared light can have the same circuit arrangement. The image sensor 1902 can include, for example, a readout unit 2002 and a vertical scanning circuit 2011. FIG. 20 shows only four pixels, that is, the R pixel 201, the G pixel 202, the B pixel 203, and the IR pixel 204 as a plurality of pixels.

The controller 1904 arranged outside the image sensor 1902 can have the function of the above-described controller 104, and a function of controlling the vertical scanning circuit 2011 and the readout unit 2002. As signals for controlling image sensing and readout of each pixel, the vertical scanning circuit 2011 has, for example, an ENABLEn signal, a RESETn signal, a READn signal, and a LATCHn signal. FIG. 20 shows an example in which the pixels have an arrangement similar to that of the pixels 201 to 204 in the first embodiment, but the arrangement of pixels in another embodiment may be adopted.

The controller 1904 may be understood as a control apparatus. The controller 1904 can be configured to control an image sensor having a plurality of pixels arranged to constitute a plurality of rows and a plurality of columns. The plurality of pixels can include the first pixels (for example, the B pixels 203) and the second pixels (for example, the IR pixels 204) that belong to the same row. The first pixels can be sensitive to light of the first wavelength range, and the second pixels can be sensitive to light of the second wavelength range different from the first wavelength range. The controller 1904 can be configured to generate the first signal that defines the image sensing period of the first pixels, and the second signal that defines the image sensing period of the second pixels in a period in which the signals of the first and second pixels are read out. In the example shown in FIG. 4, the first signal is the readout start signal that changes at time t402, and the second signal is the readout start signal that changes at time t403. The first signal can define the end of the image sensing period of the first pixels, and the second signal can define the end of the image sensing period of the second pixels.

### OTHER EMBODIMENTS

The disclosure is not limited to the above-described embodiments and can be implemented in various other forms. For example, in the first to eighth embodiments, the first wavelength range or the second wavelength range may include the wavelength range of ultraviolet light, both the first and second wavelength ranges may be wavelength ranges within the wavelength range of visible light, or the first and second wavelength ranges may be other wavelength ranges.

The image sensing device in each of the image sensing systems according to the second to eighth embodiments may be constituted by not a stereo camera but an image sensor having image plane phase difference pixels for distance measurement.

Each of the controllers in the first to eighth embodiments and each of the parallax calculation units in the second to eighth embodiments may be constituted by hardware circuits that execute various sequences, or by programs that executes sequences and processors that execute the programs.

The aspect of the embodiments may be constituted as not an image sensing system that measures a distance using a stereo camera, as in the second to eighth embodiments, but an image sensing system that performs self-localization or spatial grasp based on two types of sensed images. For example, in self-localization, Visual Simultaneous Localization and Mapping (SLAM) is proposed as a method using an image. In Visual SLAM, feature points are extracted from a plurality of images to estimate three-dimensional information of surroundings and the position and posture of a camera. Even in an environment in which a feature amount necessary for the estimation cannot be obtained by only visible light, the disclosure can be applied to obtain an image of a large feature amount and perform a higher-precision estimation.

While the disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-041584, filed Mar. 15, 2024, which is hereby incorporated by reference herein in its entirety.

What is claimed is:

1. A device comprising:
a sensor including a plurality of pixels configured to output digital data corresponding to the number of incident photons; and
a controller configured to control a projector,
wherein the plurality of pixels include a first pixel sensitive to light of a first wavelength range, and a second pixel sensitive to light of a second wavelength range,
the projector generates projection light including the second wavelength range,
the controller controls the projector to define an effective emission period in which an intensity of the projection light is higher than a predetermined intensity, and a non-effective emission period in which the intensity of the projection light is lower than the predetermined intensity,
a first period in which the first pixel performs image sensing includes at least part of the non-effective emission period, and
a second period in which the second pixel performs image sensing includes at least part of the effective emission period and at least part of the non-effective emission period.

2. The device according to claim 1, wherein the first wavelength range includes a wavelength range of visible light, and
the second wavelength range includes a wavelength range of infrared light.

3. The device according to claim 1, wherein the controller defines the effective emission period and the non-effective emission period to make one cycle include the effective emission period and the non-effective emission period.

4. The device according to claim 1, wherein the controller defines the effective emission period and the non-effective emission period to make one cycle include the non-effective emission period and the effective emission period subsequent to the non-effective emission period,
the first period is a period from a start to end of the non-effective emission period, and
the second period is a period from the start of the non-effective emission period to an end of the effective emission period.

5. The device according to claim 4, wherein each of the plurality of pixels includes a counter configured to generate digital data corresponding to the number of incident photons, and a latch circuit configured to perform a latch operation of latching an output of the counter, and
the latch circuit of each of the plurality of pixels performs the latch operation at an end of the first period, and performs the latch operation again at an end of the second period.

6. The device according to claim 5, wherein reset of the counter of each of the plurality of pixels is canceled at starts of the first period and the second period, and a count operation of the counter is enabled throughout the second period.

7. The device according to claim 6, further comprising a readout unit configured to read out digital data from the latch circuit of the first pixel after an end of the first period, and read out digital data from the latch circuit of the second pixel after an end of the second period.

8. The device according to claim 1, wherein the controller defines the effective emission period and the non-effective emission period to make one cycle include the effective emission period and the non-effective emission period subsequent to the effective emission period,
the first period starts at a start of the non-effective emission period and ends in the non-effective emission period, and
the second period starts at a start of the effective emission period and ends in the non-effective emission period.

9. The device according to claim 8, wherein each of the plurality of pixels includes a counter configured to generate digital data corresponding to the number of incident photons,
a count operation of the counter of each of the plurality of pixels is enabled at a start of the second period and disabled at an end of the second period,
reset of the counter of the first pixel is canceled at a start of the first period, and
reset of the counter of the second pixel is canceled at a start of the second period.

10. The device according to claim 9, further comprising a readout unit configured to read out digital data from the counters of the first pixel and the second pixel after an end of the first period and the end of the second period.

11. The device according to claim 1, wherein the controller defines the effective emission period and the non-effective emission period to make one cycle include the non-effective emission period and the effective emission period subsequent to the non-effective emission period,
the first period is a period from a start to end of the non-effective emission period, and
the second period starts at the start of the non-effective emission period and ends at an end of the effective emission period.

12. The device according to claim 11, wherein each of the plurality of pixels includes a counter configured to generate digital data corresponding to the number of incident photons,
reset of the counter of each of the plurality of pixels is canceled at a start of the second period,
a count operation of the counter of the first pixel is enabled at a start of the first period and disabled at an end of the first period, and
a count operation of the counter of the second pixel is enabled at a start of the second period and disabled at an end of the second period.

13. The device according to claim 12, further comprising a readout unit configured to read out digital data from the counter of the first pixel after the end of the first period, and read out digital data from the counter of the second pixel after the end of the second period.

14. The device according to claim 1, wherein the controller defines the effective emission period and the non-effective emission period to make one cycle include the non-effective emission period and the effective emission period subsequent to the non-effective emission period,
each of the plurality of pixels includes a counter configured to generate digital data corresponding to the number of incident photons,
the first period is a period until readout of digital data from the counter of the first pixel starts after the counter of the first pixel is enabled,
the second period is a period until readout of digital data from the counter of the second pixel starts after the counter of the second pixel is enabled, and
the effective emission period starts after readout of digital data from the counters of a plurality of first pixels, and ends before readout of digital data from the counters of a plurality of second pixels.

15. A control apparatus configured to control a sensor including a plurality of pixels arranged to constitute a plurality of rows and a plurality of columns, the plurality of pixels including a first pixel and a second pixel that belong to an identical row, the first pixel being sensitive to light of a first wavelength range, and the second pixel being sensitive to light of a second wavelength range,
wherein the control apparatus generates a first signal that defines an period of the first pixel, and a second signal that defines a period of the second pixel in a period in which signals of the first pixel and the second pixel are read out.

16. The apparatus according to claim 15, wherein the first signal defines an end of the period of the first pixel, and the second signal defines an end of the period of the second pixel.

17. A system comprising at least two devices, and a parallax calculation unit configured to calculate parallax based on outputs of the at least two devices,
wherein each of the at least two devices is a device defined in claim 1.

18. The system according to claim 17, wherein, in the device,
the first wavelength range includes a wavelength range of visible light, and
the second wavelength range includes a wavelength range of infrared light.

19. The system according to claim 17, wherein, in the device,
the controller defines the effective emission period and the non-effective emission period to make one image sensing cycle include the effective emission period and the non-effective emission period.

20. The system according to claim 17, wherein, in the device,
the controller defines the effective emission period and the non-effective emission period to make one image sensing cycle include the non-effective emission period and the effective emission period subsequent to the non-effective emission period,
the first image sensing period is a period from a start to end of the non-effective emission period, and
the second image sensing period is a period from the start of the non-effective emission period to an end of the effective emission period.
